(19) United States
(12) Patent Application Publication
(10) Pub. No.: US 2019/0226645 A1
(43) Pub. Date: Jul. 25, 2019

(54) LAMP

(71) Applicant: Liang Hsin Lighting (ShenZhen) Co., Ltd, Shenzhen (CN)

(72) Inventor: KUO-YI CHEN, Shenzhen (CN)

(73) Assignee: Liang Hsin Lighting (ShenZhen) Co., Ltd, Shenzhen (CN)

(21) Appl. No.: 15/922,938

(22) Filed: Mar. 16, 2018

(30) Foreign Application Priority Data
Jan. 22, 2018 (CN) 201820105114.6

(51) Int. Cl. F21K 9/233; F21K 9/237; F21K 9/238

(52) U.S. Cl. CPC F21K 9/233; F21K 9/238; F21K 9/237

(57) ABSTRACT

A lamp, including a PCB, a plurality of light sources, a lampshade, and a lamp holder connector; the plurality of light sources are arranged on the bottom surface of the PCB, the lampshade is connected with the PCB from below, the lamp holder connector is connected with a power circuit through the PCB, and the power circuit is connected with the plurality of light sources by the PCB. The present invention employs LED as the light source, thus the light will not emit upwards and emits the object directly, the reflected light loss is reduced, and the luminous efficiency is increased.

### CROSS REFERENCE TO RELATED APPLICATIONS

This application is based on and claims priority to Chinese Patent Application No. 201820105114.6, filed on Jan. 22, 2018, the entire contents of which are incorporated herein by reference.

### TECHNICAL FIELD

The disclosure relates to the technical field of lighting, in particular to a lamp.

### BACKGROUND

In the prior art, a conventional lamp usually uses the A19 bulb as a relatively concentrated spot light source, and projects light upwards in 360 degrees. Because the light emits upwards, there is a light loss close to 50%, and a question of thermal concentration.

### SUMMARY

The purpose of the disclosure is to provide a lamp to solve the problem of extensive light loss and thermal concentration in the prior art.

To this end, according to an aspect of the disclosure, it provides a lamp comprising a PCB, a plurality of light sources, a lampshade, and a lamp holder connector; the plurality of light sources are arranged on the bottom surface of the PCB, the lampshade is connected with the PCB from below, the lamp holder connector is connected with a power circuit through the PCB, and the power circuit is connected with the plurality of light sources by the PCB.

Preferably, the light source is a LED.

Preferably, the PCB is circular.

Preferably, a through-hole for mounting the lamp holder connector is formed on the PCB, the lamp holder connector is arranged in the through-hole.

Preferably, at least a part of the lamp holder connector is located in a space defined by the PCB and the lampshade.

Preferably, a concave for connecting an external lamp holder is formed on the lamp holder connector.

Preferably, a cone structure protruding downwards is formed on the PCB, the through-hole is opened on the bottom surface, being close to the lampshade, of the cone structure.

Preferably, the light sources are provided on the conical surface and/or bottom surface of the cone structure.

Preferably, the PCB is of a flat structure.

The present invention employs LED as the light source, thus the light will not emit upwards and emits the object directly, the reflected light loss is reduced, and the luminous efficiency is increased. Furthermore, it is beneficial to scatter optothermal and radiate, and the light is scattered and gentle.

### BRIEF DESCRIPTION OF THE DRAWINGS

FIG. 1 is a structural view of a first embodiment in the present invention;

FIG. 2 is a structural view of a second embodiment in the present invention.

### REFERENCE NUMERALS

1. printed circuit board (PCB); 2. light source; 3. lampshade; 4. lamp holder connector; 5. concave; 6. cone structure; 7. power circuit.

### DETAILED DESCRIPTION OF THE EMBODIMENTS

The embodiments of the disclosure will be described below in detail in conjunction with the accompanying drawings, but the disclosure may be implemented in many different ways defined and covered by Claims.

This disclosure provides a lamp, comprising a printed circuit board (PCB) 1, a plurality of light sources 2, a lampshade 3, and a lamp holder connector 4; the plurality of light sources 2 are arranged on the bottom surface of the PCB 1, the lampshade 3 is connected with the PCB 1 from below, the lamp holder connector 4 is connected with a power circuit 7 through the PCB 1, and the power circuit 7 is connected with the plurality of light sources 2 by the PCB 1. Preferably, the light source 2 is a LED.

In the above technology solution, the present invention employs LED as the light source, thus the light will not emit upwards and emits the object directly, the reflected light loss is reduced, and the luminous efficiency is increased. Furthermore, it is beneficial to scatter optothermal and radiate, and the light is scattered and gentle.

Preferably, the PCB 1 is circular. Preferably, a through-hole for mounting the lamp holder connector 4 is formed on the PCB 1, the lamp holder connector 4 is arranged in the through-hole.

Preferably, at least a part of the lamp holder connector 4 is located in a space defined by the PCB 1 and the lampshade 3. Preferably, a concave 5 for connecting an external lamp holder is formed on the lamp holder connector 4. When using, install the bottom of the external lamp holder inside the concave 5, then connect the external lamp holder with a lamp-socket in the prior art.

Preferably, a cone structure 6 protruding downwards is formed on the PCB 1, the through-hole is opened on the bottom surface, being close to the lampshade 3, of the cone structure 6.

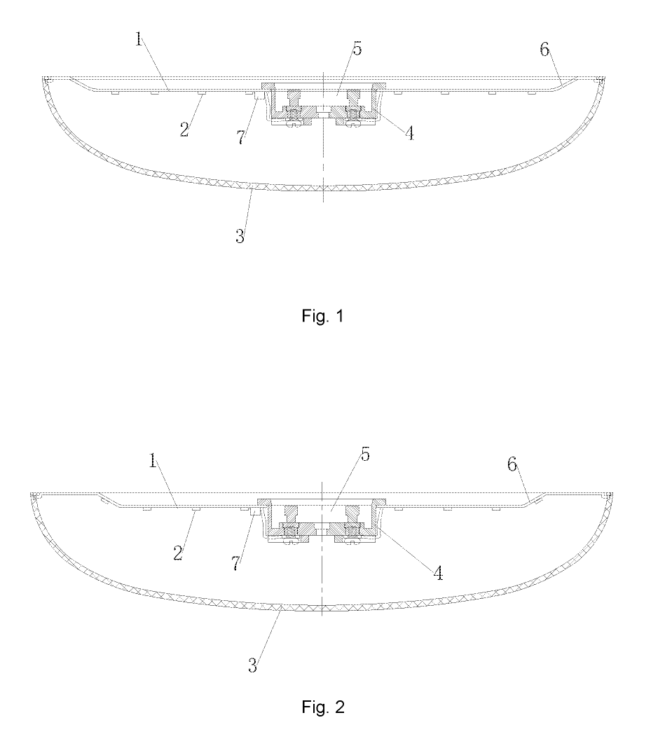

As shown in FIG. 1 and FIG. 2, preferably, the light sources 2 are provided on the conical surface and/or bottom surface of the cone structure 6.

Preferably, the PCB 1 is of a flat structure.

The above is only the preferred embodiment of the disclosure and are not intended to limit the disclosure, for those skilled in the art, various changes and variations may be made to the disclosure. Any modifications, equivalent replacements, improvements and the like within the spirit and principle of the disclosure shall be contained within the scope of protection of the claims of the disclosure.

What is claimed is:

1. A lamp, comprising a PCB, a plurality of light sources, a lampshade, and a lamp holder connector; wherein, the plurality of light sources are arranged on a bottom surface of the PCB, the lampshade is connected with the PCB from below, the lamp holder connector is connected with a power circuit through the PCB, and the power circuit is connected with the plurality of light sources by the PCB.

2. The lamp according to claim 1, wherein the plurality of light sources are LEDs.

3. The lamp according to claim 1, wherein the PCB is circular.

4. The lamp according to claim 3, wherein a through-hole for mounting the lamp holder connector is formed on the PCB, the lamp holder connector is arranged in the through-hole.

5. The lamp according to claim 4, wherein at least a part of the lamp holder connector is located in a space defined by the PCB and the lampshade.

6. The lamp according to claim 4, wherein a concave for connecting an external lamp holder is formed on the lamp holder connector.

7. The lamp according to claim 4, wherein a cone structure protruding downwards is formed on the PCB, the through-hole is opened on a bottom surface of the cone structure.

8. The lamp according to claim 7, wherein the plurality of light sources are provided on a conical surface and/or the bottom surface of the cone structure (6).

9. The lamp according to claim 4, wherein the PCB is of a flat structure.
